(19) United States
(12) Patent Application Publication
(10) Pub. No.: US 2014/0195227 A1
(43) Pub. Date: Jul. 10, 2014

(54) SYSTEM AND METHOD FOR ACOUSTIC TRANSFORMATION

(71) Applicants: Frank RUDZICZ, Toronto (CA); Graeme John HIRST, Toronto (CA); Pascal Hubert Henri Marie VAN LIESHOUT, Oakville (CA); Graham Fraser SHEIN, Toronto (CA); Gerald Bradley PENN, Thornhill (CA)

(72) Inventors: Frank RUDZICZ, Toronto (CA); Graeme John HIRST, Toronto (CA); Pascal Hubert Henri Marie VAN LIESHOUT, Oakville (CA); Graham Fraser SHEIN, Toronto (CA); Gerald Bradley PENN, Thornhill (CA)

(21) Appl. No.: 14/153,942

(22) Filed: Jan. 13, 2014

Related U.S. Application Data
(63) Continuation of application No. PCT/CA2012/050502, filed on Jul. 25, 2012.
(60) Provisional application No. 61/511,275, filed on Jul. 25, 2011.

(51) Int. Cl. G10L 15/22

(52) U.S. Cl. CPC G10L 15/22
USPC 704/231

(57) ABSTRACT

An acoustic transformation system and method. A specific embodiment is the transformation of acoustic speech signals produced by speakers with speech disabilities in order to make those utterances more intelligible to typical listeners. These modifications include the correction of tempo or rhythm, the adjustment of formant frequencies in sonorants, the removal of adjustment of aberrant voicing, the deletion of phoneme insertion errors, and the replacement of erroneously dropped phonemes. These methods may also be applied to general correction of musical or acoustic sequences.

### CROSS REFERENCE

This application claims priority from U.S. patent application Ser. No. 61/511,275 filed Jul. 25, 2011, incorporated herein by reference.

### FIELD OF THE INVENTION

The present invention relates generally to acoustic transformation. The present invention relates more specifically to acoustic transformation to improve the intelligibility of a speaker or sound.

### BACKGROUND

There are several instances where a sound is produced inaccurately, so that the sound that is heard is not the sound that was intended. Sounds of speech are routinely uttered inaccurately by speakers with dysarthria.

Dysarthria is a set of neuromotor disorders that impair the physical production of speech. These impairments reduce the normal control of the primary vocal articulators but do not affect the regular comprehension or production of meaningful, syntactically correct language. For example, damage to the recurrent laryngeal nerve reduces control of vocal fold vibration (i.e., phonation), which can result in aberrant voicing. Inadequate control of soft palate movement caused by disruption of the vagus cranial nerve may lead to a disproportionate amount of air being released through the nose during speech (i.e., hypernasality). It has also been observed that the lack of articulatory control also leads to various involuntary non-speech sounds including velopharyngeal or glottal noise. More commonly, it has been shown that a lack of tongue and lip dexterity often produces heavily slurred speech and a more diffuse and less differentiable vowel target space.

The neurological damage that causes dysarthria usually affects other physical activity as well which can have a drastically adverse affect on mobility and computer interaction. For instance, it has been shown that severely dysarthric speakers are 150 to 300 times slower than typical users in keyboard interaction. However, since dysarthric speech has been observed to often be only 10 to 17 times slower than that of typical speakers, speech has been identified as a viable input modality for computer-assisted interaction.

For example, a dysarthric individual who must travel into a city by public transportation may purchase tickets, ask for directions, or indicate intentions to fellow passengers, all within a noisy and crowded environment. Thus, some proposed solutions have involved a personal portable communication device (either handheld or attached to a wheelchair) that would transform relatively unintelligible speech spoken into a microphone to make it more intelligible before being played over a set of speakers. Some of these proposed devices result in the loss of any personal aspects, including individual affectation or natural expression, of the speaker, as the devices output a robotic sounding voice. The use of prosody to convey personal information such as one's emotional state is generally not supported by such systems but is nevertheless understood to be important to general communicative ability.

Furthermore, the use of natural language processing software is increasing, particularly in consumer facing applications. The limitations of persons afflicted with speech conditions become more pronounced as the use of and reliance upon such software increases.

It is an object of the present invention to overcome or mitigate at least one of the above disadvantages.

### SUMMARY OF THE INVENTION

The present invention provides a system and method for acoustic transformation.

In one aspect, a system for transforming an acoustic signal is provided, the system comprising an acoustic transformation engine operable to apply one or more transformations to the acoustic signal in accordance with one or more transformation rules configured to determine the correctness of each of one or more temporal segments of the acoustic signal.

In another aspect, a method for transforming an acoustic signal is provided, the method comprising: (a) configuring one or more transformation rules to determine the correctness of each of one or more temporal segments of the acoustic signal; and (b) applying, by an acoustic transformation engine, one or more transformations to the acoustic signal in accordance with the one or more transformation rules.

### DESCRIPTION OF THE DRAWINGS

The features of the invention will become more apparent in the following detailed description in which reference is made to the appended drawings wherein:

FIG. 1 is a block diagram of an example of a system providing an acoustic transformation engine;

FIG. 2 is a flowchart illustrating an example of an acoustic transformation method;

FIG. 3 is a graphical representation of an obtained acoustic signal for a dysarthric speaker and a control speaker; and

FIG. 4 is a spectrogram showing an obtained acoustic signal (a) and corresponding transformed signal (b).

### DETAILED DESCRIPTION

The present invention provides a system and method of acoustic transformation. The invention comprises an acoustic transformation engine operable to transform an acoustic signal by applying one or more transformations to the acoustic signal in accordance with one or more transformation rules. The transformation rules are configured to enable the acoustic transformation engine to determine the correctness of each of one or more temporal segments of the acoustic signal.

Segments that are determine to be incorrect may be morphed, transformed, replaced or deleted. A segment can be inserted into an acoustic signal having segments that are determined to be incorrectly adjacent. Incorrectness may be defined as being perceptually different than that which is expected.

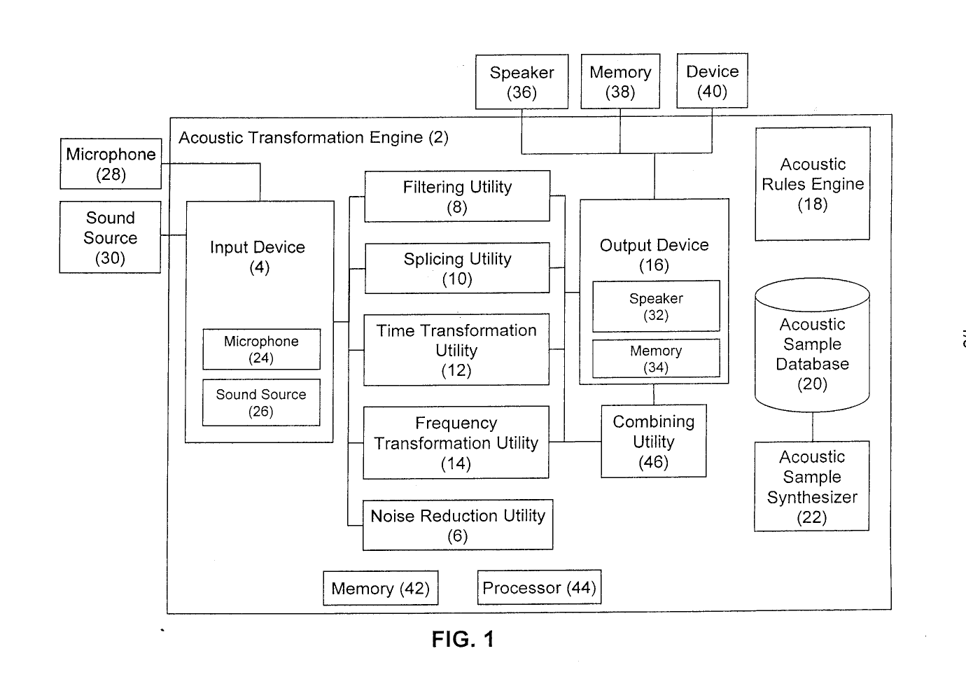

Referring to FIG. 1, a system providing an acoustic transformation engine (2) is shown. The acoustic transformation engine (2) comprises an input device (4), a filtering utility (8), a splicing utility (10), a time transformation utility (12), a frequency transformation utility (14) and an output device (16). The acoustic transformation engine further includes an acoustic rules engine (18) and an acoustic sample database (20). The acoustic transformation engine may further comprise a noise reduction utility (6), an acoustic sample synthesizer (22) and a combining utility (46).

The input device is operable to obtain an acoustic signal that is to be transformed. The input device may be a microphone (24) or other sound source (26), or may be an input communicatively linked to a microphone (28) or other sound source (30). A sound source could be a sound file stored on a memory or an output of a sound producing device, for example.

The noise reduction utility may apply noise reduction on the acoustic signal by applying a noise reduction algorithm, such as spectral subtraction, for example. The filtering utility, splicing utility, time transformation utility and frequency transformation utility then apply transformations on the acoustic signal. The transformed signal may then be output by the output device. The output device may be a speaker (32) or a memory (34) configured to store the transformed signal, or may be an output communicatively linked to a speaker (36), a memory (38) configured to store the transformed signal, or another device (40) that receives the transformed signal as an input.

The acoustic transformation engine may be implemented by a computerized device, such as a desktop computer, laptop computer, tablet, mobile device, or other device having a memory (42) and one or more computer processors (44). The memory has stored thereon computer instructions which, when executed by the one or more computer processors, provide the functionality described herein.

The acoustic transformation engine may be embodied in an acoustic transformation device. The acoustic transformation device could, for example, be a handheld computerized device comprising a microphone as the input device, a speaker as the output device, and one or more processors, controllers and/or electric circuitry implementing the filtering utility, splicing utility, time transformation utility and frequency transformation utility.

One particular example of such an acoustic transformation device is a mobile device embeddable within a wheelchair. Another example of such an acoustic transformation device is an implantable or wearable device (which may preferably be chip-based or another small form factor). Another example of such an acoustic transformation device is a headset wearable by a listener of the acoustic signal.

The acoustic transformation engine may be applied to any sound represented by an acoustic signal to transform, normalize, or otherwise adjust the sound. In one example, the sound may be the speech of an individual. For example, the acoustic transformation engine may be applied to the speech of an individual with a speech disorder in order to correct their pronunciation, tempo, and tone.

In another example, the sound may be from a musical instrument. In this example, the acoustic transformation engine is operable to correct the pitch of an untuned musical instrument or modify incorrect notes and chords but it may also insert or remove missed or accidental sounds, respectively, and correct for the length of those sounds in time.

In yet another example, the sound may be a pre-recorded sound that is synthesized to resemble a natural sound. For example, a vehicle computer may be programmed to output a particular sound that resembles an engine sound. In time, the outputting sound can be affected by external factors. The acoustic transformation engine may be applied to correct the outputted sound of the vehicle computer.

The acoustic transformation engine may also be applied to the synthetic imitation of a specific human voice. For example, one voice actor can be made to sound more like another by modifying voice characteristics of the former to more closely resemble the latter.

While there are numerous additional examples for the application of the acoustic transformation engine, for simplicity the present disclosure describes the transformation of speech. It more particularly describes the transformation of dysarthric speech. It will be appreciated that transformation of other speech and other sounds could be provided using substantially similar techniques as those described herein.

The acoustic transformation engine can preserve the natural prosody (including pitch and emphasis) of an individual's speech in order to preserve extra-lexical information such as emotions.

The acoustic sample database may be populated with a set of synthesized sample sounds produced by an acoustic sample synthesizer. The acoustic sample synthesizer may be provided by a third-party (e.g., a text-to-speech engine) or may be included in the acoustic transformation engine. This may involve, for example, resampling the synthesized speech using a polyphase filter with low-pass filtering to avoid aliasing with the original spoken source speech.

In another example, an administrator or user of the acoustic transformation engine could populate the acoustic sample database with a set of sample sound recordings. In an example where the acoustic transformation engine is applied to speech, the sample sounds correspond to versions of appropriate or expected speech, such as pre-recorded words.

In the example of dysarthric speech, a text-to-speech algorithm may synthesize phonemes using a method based on linear predictive coding with a pronunciation lexicon and part-of-speech tagger that assists in the selection of intonation parameters. In this example. the acoustic sample database is populated with expected speech given text or language uttered by the dysarthric speaker. Since the discrete phoneme sequences themselves can differ, an ideal alignment can be found between the two by the Levenshtein algorithm, which provides the total number of insertion, deletion, and substitution errors.

The acoustic rules engine may be configured with rules relating to empirical findings of improper input acoustic signals. For example, where the acoustic transformation engine is applied to speech that is produced by a dysarthric speaker, the acoustic rules engine may be configured with rules relating to common speech problems for dysarthric speakers. Furthermore, the acoustic rules engine could include a learning algorithm or heuristics to adapt the rules to a particular user or users of the acoustic transformation engine, which provides customization for the user or users.

In the example of dysarthric speech, the acoustic rules engine may be configured with one or more transformation rules corresponding to the various transformations of acoustics. Each rule is provided to correct a particular type of error likely to be caused by dysarthria as determined by empirical observation. An example of a source of such observation is the TORGO database of dysarthric speech.

The acoustic transformation engine applies the transformations to an acoustic signal provided by the input device in accordance with the rules.

The acoustic rules engine may apply automated or semi-automated annotation of the source speech to enable more accurate word identification. This is accomplished by advanced classification techniques similar to those used in automatic speech recognition, but to restricted tasks. There are a number of automated annotation techniques that can be applied, including, for example, applying a variety of neural networks and rough sets to the task of classifying segments of speech according to the presence of stop-gaps, vowel prolongations, and incorrect syllable repetitions. In each case, input includes source waveforms and detected formant frequencies. Stop-gaps and vowel prolongations may be detected with high (about 97.2%) accuracy and vowel repetitions may be detected with high (about up to 90%) accuracy using a rough set method. Accuracy may be similar using more traditional neural networks. These results may be generally invariant even under frequency modifications to the source speech. For example, disfluent repetitions can be identified reliably through the use of pitch, duration, and pause detection (with precision up to about 93%). If more traditional models of speech recognition to identify vowels are implemented, the probabilities that they generate across hypothesized words might be used to weight the manner in which acoustic transformations are made. If word-prediction is to be incorporated, the predicted continuations of uttered sentence fragments can be synthesized without requiring acoustic input.

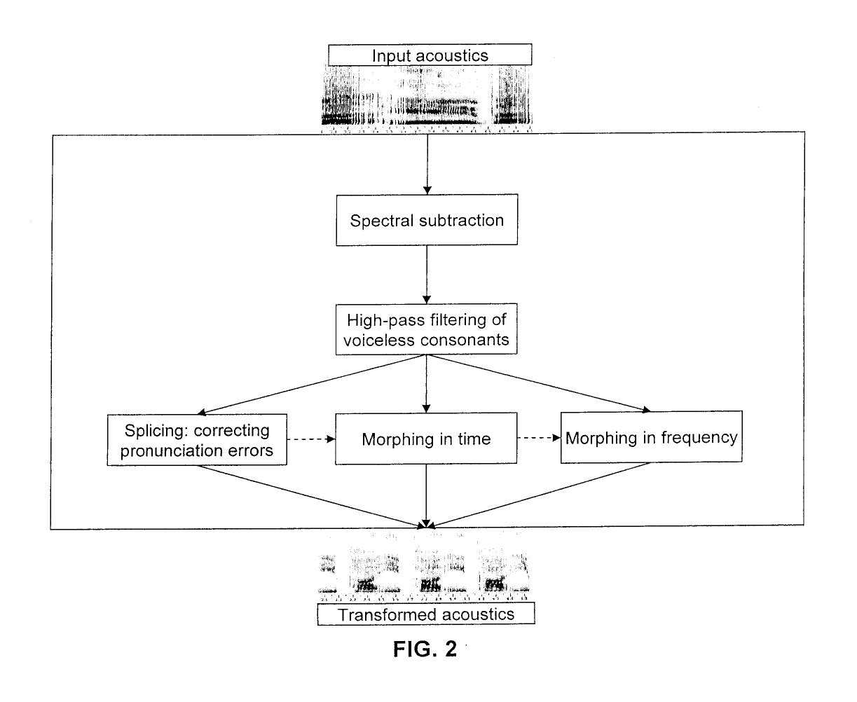

Referring now to FIG. 2, an example method of acoustic transformation provided by the acoustic transformation engine is shown. The input device obtains an acoustic signal; the acoustic signal may comprise a recording of acoustics on multiple channels simultaneously, possibly recombining them later as in beam-forming. Prior to applying the transformations, the acoustic transformation engine may apply noise reduction or enhancement (for example, using spectral subtraction), and automatic phonological, phonemic, or lexical annotations. The transformations applied by the acoustic transformation engine may be aided by annotations that provide knowledge of the manner of articulation, the identities of the vowel segments, and/or other abstracted speech and language representations to process an acoustic signal.

The spectrogram or other frequency-based or frequency-derived (e.g. cepstral) representation of the acoustic signal may be obtained with a fast Fourier transform (FFT), linear predictive coding, or other such method (typically by analyzing short windows of the time signal). This will typically (but not necessarily) involve a frequency-based or frequency-derived representation in which that domain is encoded by a vector of values (e.g., frequency bands). This will typically involve a restricted range for this domain (e.g., 0 to 8 kHz in the frequency domain). Voicing boundaries may extracted in a unidimensional vector aligned with the spectrogram; this can be accomplished by using Gaussian Mixture Models (GMMs) or other probability functions trained with zero-crossing rate, amplitude, energy and/or the spectrum as input parameters, for example. A pitch (based on the fundamental frequency F₀) contour may he extracted from the spectrogram by a method which uses a Viterbi-like potential decoding of F₀ traces described by cepstral and temporal features. It can be shown that an error rate of less than about 0.14% in estimating F₀ contours can be achieved, as compared with simultaneously-recorded electroglottograph data. Preferably, these contours are not modified by the transformations, since in some applications of the acoustic transformation engine, using the original F₀ results in the highest possible intelligibility.

The transformations may comprise filtering, splicing, time morphing and frequency morphing. In one example of applying the acoustic transformation to dysarthric speech, each of the transformations may be applied. In other applications, one or more of the transformations may not need to be applied. The transformations to apply can be selected based on expected issues with the acoustic signal, which may be a product of what the acoustic signal represents.

Furthermore, the transformations may be applied in any order. The order of applying transformations may be a product of the implementation or embodiment of the acoustic transformation engine. For example, a particular processor implementing the acoustic transformation engine may be more efficiently utilized when applying transformations in a particular order, whether based on the particular instruction set of the processor, the efficiency of utilizing pipelining in the processor, etc.

Furthermore, certain transformations may be applied independently, including in parallel. These independently transformed signals can then be combined to produce a transformed signal. For example, formant frequencies of vowels in a word can be modified while the correction of dropped or inserted phonemes is performed in parallel, and these can be combined thereafter by the combining utility using, for example, time-domain pitch-synchronous overlap-add (TD-PSOLA). Other transformations may be applied in series (e.g., in certain examples, parallel application of removal of acoustic noise with formant modifications may not provide optimal output).

The filtering utility applies a filtering transformation. In an example of applying the acoustic transformation engine to dysarthric speech, the filtering utility may be configured to apply a filter based on information provided by the annotation source

For example, the TORGO database indicates that unvoiced consonants are improperly voiced in up to 18.7% of plosives (e.g. /d/ for /t/) and up to 8.5% of fricatives (e.g. /v/ for /f/) in dysarthric speech. Voiced consonants are typically differentiated from their unvoiced counterparts by the presence of the voice bar, which is a concentration of energy below 150 Hz indicative of vocal fold vibration that often persists throughout the consonant or during the closure before a plosive. The TORGO database also indicates that for at least two male dysarthric speakers this voice bar extends considerably higher, up to 250 Hz.

In order to correct these mispronunciations, the filtering utility filters out the voice bar of all acoustic sub-sequences annotated as unvoiced consonants. The filter, in this example, may he a high-pass Butterworth filter, which is maximally flat in the passband and monotonic in magnitude in the frequency domain. The Butterworth filter may be configured using on a normalized frequency range respecting the Nyquist frequency, so that if a waveform's sampling rate is 16 kHz, the normalized cutoff frequency for this component is f*_{Norm}=250/(1.6×10⁴/2)=3.125×10⁻². This Butterworth filter is an all-pole transfer function between signals. The filtering utility may apply a 10^{th}-order low-pass Butterworth filter whose magnitude response is

$${\vert ℬ ( z ; 10 ) \vert}^{2} = {\vert H ( z ; 10 ) \vert}^{2} = \frac{1}{1 + {( \frac{j z}{j {z}_{Norm}^{*}} )}^{2 \times 10}}$$

where z is the complex frequency in polar coordinates and z*_{Norm} is the cutoff frequency in that domain. This provides the transfer function

$$ℬ ( z ; 10 ) = H ( z ; 10 ) = \frac{1}{1 + {z}^{10} + {\sum }_{i = 1}^{10} {c}_{t} {z}^{10 {-}_{t}}}$$

whose poles occur at known symmetric intervals around the unit complex-domain circle. These poles may then be transformed by a function that produces the state-space coefficients αᵢ and βᵢ that describe the output signal resulting from applying the low-pass Butterworth filter to the discrete signal x[n]. These coefficients may further be converted by

ā=z _{N̅orm} α̅⁻¹

b̅=−z _{N̅orm}( α̅⁻¹ β̅)

giving the high-pass Butterworth filter with the same cutoff frequency of z*_{Norm}. This continuous system may be converted to a discrete equivalent thereof using an impulse-invariant discretization method, which may be provided by the difference equation

$$γ [ n ] = {\sum }_{k = 1}^{10} {α}_{k} γ [ n - k ] + {\sum }_{k = 0}^{10} {b}_{k} x [ n - k ]$$

As previously mentioned, this difference equation may be applied to each acoustic sub-sequence annotated as unvoiced consonants, thereby smoothly removing energy below 250 Hz. Thresholds other than 250 Hz can also be used.

The splicing utility applies a splicing transformation to the acoustic signal. The splicing transformation identifies errors with the acoustic signal and splices the acoustic signal to remove an error or splices into the acoustic signal a respective one of the set of synthesized sample sounds provided by the acoustic sample synthesizer (22) to correct an error.

In an example of applying the acoustic transformation engine to dysarthric speech, the splicing transformation may implement the Levenshtein algorithm to obtain an alignment of the phoneme sequence in actually uttered speech and the expected phoneme sequence, given the known word sequence. Isolating phoneme insertions and deletions includes iteratively adjusting the source speech according to that alignment. There may be two cases where action is required, insertion error and deletion error.

Insertion error refers to an instance that a phoneme is present where it ought not be. This information may be obtained from the annotation source. In the TORGO database, for example, insertion errors tend to be repetitions of phonemes occurring in the first syllable of a word. When an insertion error is identified the entire associated segment of the acoustic signal may be removed. In the case that the associated segment is not surrounded by silence, adjacent phonemes may be merged together with TD-PSOLA.

Deletion error refers to an instance that a phoneme is not present where it ought to be. This information may be obtained from the annotation source. In the TORGO database, the vast majority of accidentally deleted phonemes are fricatives, affricates, and plosives. Often, these involve not properly pluralizing nouns (e.g., book instead of books). Given their high preponderance of error, these phonemes may be the only ones inserted into the dysarthric source speech. Specifically, when the deletion of a phoneme is recognized with the Levenshtein algorithm, the associated segment from the aligned synthesized speech may be extracted and inserted into the appropriate segment in the uttered speech. For all unvoiced fricatives, affricates, and plosives, no further action may be required. When these phonemes are voiced, however, the F₀ curve from the synthetic speech may be extracted and removed, the F₀ curve may be linearly interpolated from adjacent phonemes in the source dysarthric speech, and the synthetic spectrum may be resynthesized with the interpolated F₀. If interpolation is not possible (e.g., the synthetic voiced phoneme is to be inserted beside an unvoiced phoneme), a flat F₀ equal to the nearest natural F₀ curve can be generated.

The time transformation utility applies a time transformation. The time transformation transforms particular phonemes or phoneme sequences based on information obtained from the annotation source. The time transformation transforms the acoustic signal to normalize, in time, the several phonemes and phoneme sequences that comprise the acoustic signal. Normalization may comprise contraction or expansion in time, depending on whether the particular phoneme or phoneme sequence is longer or shorter, respectively, than expected.

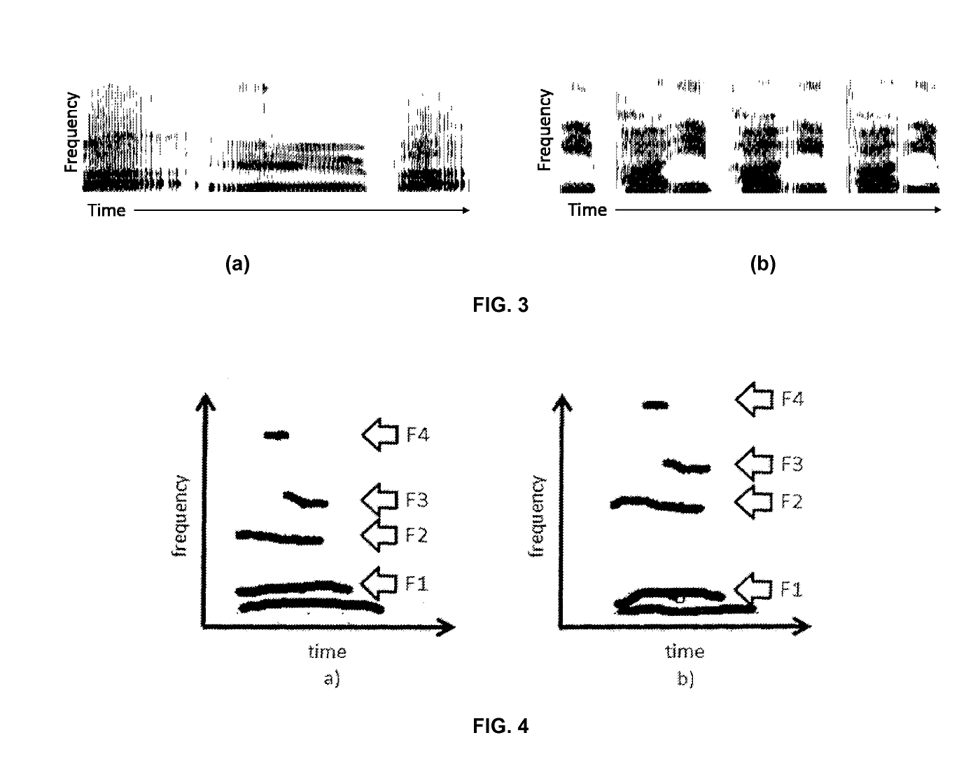

Referring now to FIG. 3, which corresponds to information obtained from the TORGO database, in an example of applying the acoustic transformation engine to dysarthric speech, it can be observed that vowels uttered by dysarthric speakers are significantly slower than those uttered by typical speakers. In fact, it can be observed that sonorants are about twice as long in dysarthric speech, on average. In the time transformation, phoneme sequences identified as sonorant may be contracted in time in order to be equal in extent to the greater of half their original length or the equivalent synthetic phoneme's length.

The time transformation preferably contracts or expands the phoneme or phoneme sequence without affecting its pitch or frequency characteristics. The time transformation utility may apply a phase vocoder, such as a vocoder based on digital short-time Fourier analysis, for example. In this example, Hamming-windowed segments of the uttered phoneme are analyzed with a z-transform providing both frequency and phase estimates for up to 2048 frequency bands. During pitch-preserving timescaled warping, the magnitude spectrum is specified directly from the input magnitude spectrum with phase values chosen to ensure continuity. Specifically, for the frequency band at frequency F and frames j and k>j in the modified spectrogram, the phase θ may be predicted by

θₖ^{(F)}=θⱼ^{(F)}+2πF(j−k)

In this case the discrete warping of the spectrogram may comprise decimation by a constant factor. The spectrogram may then be converted into a time-domain signal modified in tempo but not in pitch relative to the original phoneme segment. This conversion may be accomplished using an inverse Fourier transform.

The frequency transformation utility applies a frequency transformation. The frequency transformation transforms particular formants based on information obtained from the annotation source. The frequency transformation transforms the acoustic signal to enable a listener to better differentiate between formants. The frequency transformation identifies formant trajectories in the acoustic signal and transforms them according to an expected identity of a segment of the acoustic signal.

In an example of applying the acoustic transformation engine to dysarthric speech, formant trajectories inform the listener as to the identities of vowels, but the vowel space of dysarthric speakers tends to be constrained. In order to improve a listener's ability to differentiate between the vowels, the frequency transformation identifies formant trajectories in the acoustics and modifies these according to the known vowel identity of a segment.

Formants may be identified with a 14th-order linear-predictive coder with continuity constraints on the identified resonances between adjacent frames, for example. Bandwidths may be determined by a negative natural logarithm of the pole magnitude, for example as implemented in the STRAIGHT™ analysis system.

For each identified vowel and each accidentally inserted vowel (unless previously removed by the splicing utility) in the uttered speech, formant candidates may be identified at each frame in time up to 5 kHz. Only those time frames having at least 3 such candidates within 250 Hz of expected values may be considered (other ranges can also be applied instead). The first three formants in general contain the most information pertaining to the identity of the sonorant, but this method can easily be extended to 4 or more formants, or reduced to 2 or less. The expected values of formants may, for example, be derived by identifying average values for formant frequencies and bandwidths given large amounts of English data. Any other look-up table of formant bandwidths and frequencies would be equally appropriate, and can include manually selected targets not obtained directly from data analysis. Given these subsets of candidate time frames in the vowel, the one having the highest spectral energy within the middle portion, for example 50%, of the length of the vowel may be selected as the anchor position, and the formant candidates within the expected ranges may be selected as the anchor frequencies for formants F₁ to F₃. If more than one formant candidate falls within expected ranges, the one with the lowest bandwidth may be selected as the anchor frequency.

Given identified anchor points and target sonorant-specific frequencies and bandwidths, there are several methods to modify the spectrum. One such method, for example, is to learn a statistical conversion function based on Gaussian mixture mapping, which may be preceded by alignment of sequences using dynamic time warping. This may include the STRAIGHT morphing, as previously described, among others. The frequency transformation of a frame of speech x_{A} for speaker A may be performed with a multivariate frequency-transformation function T_{Aβ} given known targets β using

$$\begin{matrix}{T}_{A β} ( {x}_{A} ) = {\int }_{0}^{{x}_{A}} exp ( log ( \frac{δ {T}_{A β} ( λ )}{δ λ} ) ) δλ \\ = {\int }_{0}^{{x}_{A}} exp ( ( 1 - r ) log ( \frac{δ {T}_{A A} ( λ )}{δ λ} ) + r log ( \frac{δ {T}_{A β} ( λ )}{δλ} ) ) δλ \\ = {\int }_{0}^{{x}_{A}} {( \frac{δ {T}_{A β} ( λ )}{δ λ} )}^{γ} δλ\end{matrix}$$

where λ is the frame-based time dimension and 0≦r≦1 is an -tive rate at which to perform morphing (i.e., r−1 implies complete conversion of the parameters of speaker A to parameter set β and r=0 implies no conversion.) Referring now to FIG. 4, an example of the results of this morphing technique may have three identified formants shifted to their expected frequencies. The indicated black lines labelled F1, F2, F3, and F4 are example formants, which are concentrations of high energy within a frequency band over time and which are indicative of the sound being uttered. The locations of these formants being changed changes the way the utterance sounds.

The frequency transformation tracks formants and warps the frequency space automatically. The frequency transformation may additionally implement Kalman filters to reduce noise caused by trajectory tracking. This may provide significant improvements in formant tracking, especially for F₁.

The transformed signal may be output using the output device, saved onto a storage device, or transmitted over a transmission line

An experiment was performed in which the intelligibility of both purely synthetic and modified speech signals were measured objectively by a set of participants who transcribe what they hear from a selection of word, phrase, or sentence prompts. Orthographic transcriptions are understood to provide a more accurate predictor of intelligibility among dysarthric speakers than the more subjective estimates used in clinical settings.

In one particular experiment each participant was seated at a personal computer with a simple graphical user interface with a button which plays or replays the audio (up to 5 times), a text box in which to write responses, and a second button to submit those responses. Audio was played over a pair of headphones. The participants were told to only transcribe the words with which they are reasonably confident and to ignore those that they could not discern. They were also informed that the sentences are grammatically correct but not necessarily semantically coherent, and that there is no profanity. Each participant listened to 20 sentences selected at random with the constraints that at least two utterances were taken from each category of audio, described below, and that at least five utterances were also provided to another listener, in order to evaluate inter-annotator agreement. Participants were self-selected to have no extensive prior experience in speaking with individuals with dysarthria, in order to reflect the general population. No cues as to the topic or semantic context of the sentences were given. In this experiment, sentence-level utterances from the TORGO database were used.

Baseline performance was measured on the original dysarthric speech. Two other systems were used for reference, a commercial text-to-speech system and the Gaussian mixture mapping method.

In the commercial text-to-speech system, word sequences are produced by the Cepstral™ software using the U.S. English voice ‘David’, which is similar to the text-to-speech application described previously herein. This approach has the disadvantage that synthesized speech will not mimic the user's own acoustic patterns, and will often sound more mechanical or robotic due to artificial prosody.

The Gaussian mixture mapping model involves the FestVox™ implementation which includes pitch extraction, some phonological knowledge, and a method for resynthesis. Parameters for this model are trained by the FestVox system using a standard expectation-maximization approach with 24th-order cepstral coefficients and four Gaussian components. The training set consists of all vowels uttered by a male speaker in the TORGO database and their synthetic realizations produced by the method above.

Performance was evaluated on the three transformations provided by the acoustic transformation engine, namely splicing, time transformation and frequency transformation. In each case, annotator transcriptions were aligned with the ‘true’ or expected sequences using the Levenshtein algorithm previously described herein. Plural forms of singular words, for example, were considered incorrect in word alignment. Words were split into component phonemes according to the CMU™ dictionary, with words having multiple pronunciations given the first decomposition therein.

The experiment showed that the transformations applied by the acoustic transformation engine increased intelligibility of a dysarthric speaker.

There are several applications for the acoustic transformation engine.

One example application is a mobile device application that can be used by a speaker with a speech disability to transform their speech so as to be more intelligible to a listener. The speaker can speak into a microphone of the mobile device and the transformed signal can be provided through a speaker of the mobile device, or sent across a communication path to a receiving device. The communication path could be a phone line, cellular connection, internet connection, WiFi, Bluetooth™, etc. The receiving device may or may not require an application to receive the transformed signal, as the transformed signal could be transmitted as a regular voice signal would be typically transmitted according to the protocol of the communication path.

In another example application, two speakers on opposite ends of a communication path could be provided with a real time or near real time pronunciation translation to better engage in a dialogue. For example, two English speakers from different locations, wherein each has a particular accent, can be situated on opposite ends of a communication path. In communication between speaker A to speaker B, a first annotation source can be automatically annotated in accordance with annotations using speaker B's accent so that utterances by speaker A can be transformed to speaker B's accent, while a second annotation source can be automatically annotated in accordance with annotations using speaker A's accent so that utterances by speaker B can be transformed to speaker A's accent. This example application scales to n-speakers, as each speaker has their own annotation source with which each other speaker's utterances can be transformed.

Similarly, in another example application, a speaker's (A) voice could be transformed to sound like another speaker (B). The annotation source may be annotated in accordance with speaker B's speech, so that speaker A's voice is transformed to acquire speaker B's pronunciation, tempo, and frequency characteristics.

In another example application, acoustic signals that have been undesirably transformed in frequency (for example, by atmospheric conditions or unpredictable Doppler shifts) can be transformed to their expected signals. This includes a scenario in which speech uttered in a noisy environment (e.g., yelled) can be separated from the noise and modified to be more appropriate.

Another example application is to automatically tune a speaker's voice to transform it to make it sound as if the speaker is singing in tune with a musical recording, or music being played. The annotation source may be annotated using the music being played so that the speaker's voice follows the rhythm and pitch of the music.

These transformations can also be applied to the modification of musical sequences. For instance, in addition to the modification of frequency characteristics that modify one note or chord to sound more like another note or chord (e.g., key changes), these modifications can also be used to correct for aberrant tempo, to insert notes or chords that were accidentally omitted, or to delete notes or chords that were accidentally inserted.

Although the invention has been described with reference to certain specific embodiments, various modifications thereof will be apparent to those skilled in the art without departing from the spirit and scope of the invention as outlined in the claims appended hereto. The entire disclosures of all references recited above are incorporated herein by reference.

We claim:

1. A system for transforming an acoustic signal comprising an acoustic transformation engine operable to apply one or more transformations to the acoustic signal in accordance with one or more transformation rules configured to determine the correctness of each of one or more temporal segments of the acoustic signal.

2. The system of claim 1, wherein the acoustic transformation engine is operable to morph or transform a segment determined to be incorrect.

3. The system of claim 1, wherein the acoustic transformation engine is operable to replace a segment determined to be incorrect with a sample sound.

4. The system of claim 1, wherein the acoustic transformation engine is operable to delete a segment determined to be incorrect.

5. The system of claim 1, wherein the acoustic transformation engine is operable to insert a sample sound or synthesize a sound between two segments determined to be incorrectly adjacent.

6. The system of claim 1, wherein the transformations comprise one or more of filtering, splicing, time transforming and frequency transforming.

7. The system of claim 1, wherein the transformation rules relate to empirical findings of improper acoustic signals.

8. The system of claim 1, wherein the transformation rules apply automated or semi-automated annotation of the acoustic signal to identify the segments.

9. The system of claim 1, wherein applying the transformations comprises obtaining a reference signal or reference parameters from an acoustic sample database.

10. The system of claim 1, wherein the acoustic transformation engine applies the transformations in parallel and combines transformed acoustic signals to produce a transformed signal.

11. A method for transforming an acoustic signal comprising:
(a) configuring one or more transformation rules to determine the correctness of each of one or more temporal segments of the acoustic signal; and
(b) applying, by an acoustic transformation engine, one or more transformations to the acoustic signal in accordance with the one or more transformation rules.

12. The method of claim 11, further comprising morphing or transforming a segment determined to be incorrect.

13. The method of claim 11, further comprising replacing a segment determined to be incorrect with a sample sound.

14. The method of claim 11, further comprising deleting a segment determined to be incorrect.

15. The method of claim 11, further comprising inserting a sample sound or synthesizing a sound between two segments determined to be incorrectly adjacent.

16. The method of claim 11, wherein the transformations comprise one or more of filtering, splicing, time transforming and frequency transforming.

17. The method of claim 11, wherein the transformation rules relate to empirical findings of improper acoustic signals.

18. The method of claim 11, wherein the transformation rules apply automated or semi-automated annotation of the acoustic signal to identify the segments.

19. The method of claim 11, wherein applying the transformations comprises obtaining a reference signal or reference parameters from an acoustic sample database.

20. The method of claim 11, further comprising applying the transformations in parallel and combining transformed acoustic signals to produce a transformed signal.
